(19) United States
(12) Patent Application Publication
(10) Pub. No.: US 2006/0144058 A1
(43) Pub. Date: Jul. 6, 2006

(54) Refrigerating device

(76) Inventors: Wolfgang Kentner, Rofingen (DE); Harald Krau, Aalen (DE)

Correspondence Address: John T Winburn;BSH Home Appliances Corporation, 100 Bosch Blvd, New Bern, NC, 28562, US

(21) Appl. No.: 10/544,285

(22) PCT Filed: Feb. 5, 2004
(86) PCT No.: PCT/EP04/01071

§ 371 Date: Aug. 3, 2005

(30) Foreign Application Priority Data
Feb. 5, 2003 (DE) 20301800.1

(51) Int. Cl. G01K 13/00; F25D 23/00; F25D 11/02

(52) U.S. Cl. 62/129; 62/264; 62/441

(57) ABSTRACT

A refrigeration appliance including a housing and a refrigerated inner area closable by a door. A carrier module in the housing including a control circuit the refrigerating capacity of the inner area according to a temperature measuring signal from the inner area. The carrier module also includes at least one control element for adjusting at least one operational parameter and/or a display element for displaying at least one operational parameter and at least one illuminating agent for illuminating the inner area.

The present invention relates to a refrigeration appliance, more precisely the structure of a housing for such an appliance.

Such a refrigeration appliance housing is conventionally constructed from an inner wall made of deep-drawn plastic and an outer wall, which, depending on the design of the appliance as an upright appliance or as a built-in appliance, can be constructed in different ways and which together with the inside wall delimits a cavity filled with insulating foam material. The upper termination of the housing of an upright appliance is formed by an element commonly designated as a table plate, which covers the upper side of the appliance, has a fixed, hard-wearing outer surface and is hollow inside. The inner cavity can be used to mount electronic parts therein, which control the function of the refrigeration appliance. These electronic components must be connected electrically to a plurality of structural groups of the appliance, e.g. to a temperature sensor arranged in the inner area, to a refrigerating machine for controlling its operation depending on the temperature detected by the temperature sensor, to operating elements and/or display elements for adjusting or respectively displaying operational parameters of the refrigeration appliance, to inner area illumination, to a door opening switch for detecting the opening of the door and for switching on and off the inner area illumination depending on the status of the door. etc.

The object of the present invention is to provide a refrigeration appliance, wherein the expense for the connections of the control circuit with diverse functional groups of the refrigerating appliance is minimised.

This task is solved by a refrigeration appliance having the features of Claim 1.

By relocating all functional elements, to be arranged in the cool box of the refrigeration appliance not necessarily for reasons of temperature function, such as the operating and power electronics, the main appliance switch, the cool box illumination and the switches for the cool box illumination there is no need to install supply lines for these functional elements through the insulating foam layer. The compact, integral arranging of these functional elements on the carrier module allows assembly of the modules in particular in time-saving large-scale production, by which the overall manufacture of a refrigeration appliance is considerably simplified, because only the elements necessary for temperature control, such as temperature sensor, cool box heating as so-called “winter switch”, are assigned to the cool room, and thus only electrical lines and the signal lines for these elements are to be laid in the insulating foam of the refrigeration appliance.

In addition, the error case of error diagnosis is clearly improved.

A compartment for the carrier module is preferably formed in a table plate of the housing.

At least one pair of complementary pin-and-socket connectors should be arranged on the carrier module and on the compartment to at least furnish supply voltage for the control circuit mounted on the carrier module, a measuring signal from a temperature sensor to the control circuit and/or a control signal from the control circuit to the refrigerating machine of the refrigeration appliance.

As a result of a first preferred embodiment the carrier module can be slid into the compartment, and the pin-and-socket connectors are arranged in a manner self-contacting during sliding in, e.g. in which one pin-and-socket connector of the pair in each case is arranged solid with the carrier module and the other solid on a rear wall of the compartment, against which the carrier module is pressed when being slid in.

As a result of a second preferred embodiment the pin-and-socket connector of the compartment is arranged on a mobile cable, and the carrier module has a strain relief, to which the cable can be attached. Such a strain relief can be formed advantageously in the form of a meandering channel, in which the cable can be placed, preferably clamped.

It is also appropriate that a free outer face of the carrier module faces an upper edge of the door, and that at least one window is formed in the free outer face, through which the inner area can be lit up by the at least one illuminating agent mounted on the carrier module at least when the door is open.

A glass pane is preferably arranged in the window to protect the illuminating agent.

This glass pane can be solid with the carrier module. The result thereof is that the carrier module must be separated from the refrigeration appliance for exchanging the illuminating agent, yet this effectively represents a security advantage as compared to conventional refrigeration appliances, in which the terminal contacts of the illuminating agent are under constant tension when the door is open and thus the risk cannot be excluded of a person coming into contact with live components as an illuminating agent is being exchanged, while this is not an issue with the carrier module removed from the appliance.

In this case it is preferred that the carrier module on an inside face bears a removable housing, which the illuminating agent covers and can be removed for exchanging an illuminating agent.

A door-opening sensor for switching on and off the illuminating agent is preferably likewise arranged on the carrier module.

By equipping the refrigeration device interior with tray-shaped cool goods trays which can be withdrawn like a drawer from the cool room, in combination with the cool box illumination integrated in the tray compartment or respectively table plate by the carrier module, the result for each of the cool goods compartments when being moved out is particularly intensive lighting, in particular when the tray compartment or respectively table plate and thus the carrier module integrated therein with the cool box illumination protrudes opposite the appliance front.

Further features and advantages of the invention will emerge from the following description of embodiments with reference to the attached figures, in which:

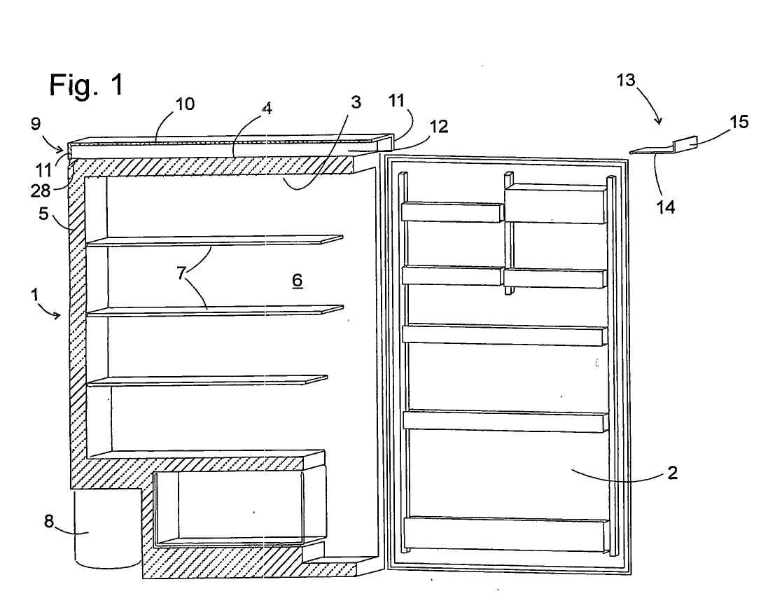

FIG. 1 shows a schematic section through an inventive refrigeration appliance;

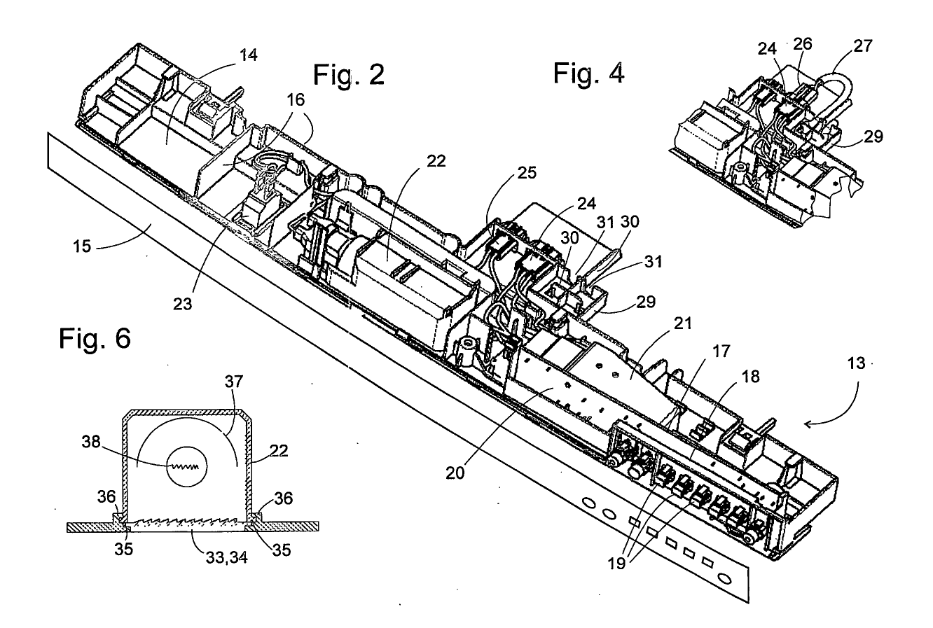

FIG. 2 is a perspective view of a carrier module for the inventive refrigeration appliance;

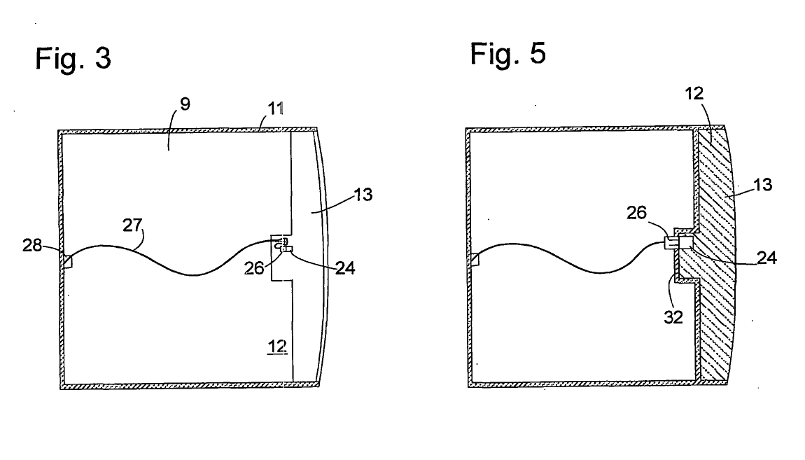

FIG. 3 shows a schematic section through the table plate of the refrigerating appliance;

FIG. 4 shows a section of FIG. 2 with attached cable;

FIG. 5 shows a horizontal section through a table plate according to a second embodiment of the invention; and

FIG. 6 shows a partial section through the carrier module at the level of the illuminating agent housing.

FIG. 1 shows a schematic section through an inventive refrigeration appliance with a body 1 and a door 2 attached thereto, illustrated in the open position. Both the body 1 and the door 2 have a double-shell construction with an inside wall 3 and an outer wall 4, tightly enclosing a cavity 5 filled with insulating foam. The inner area 6 of the refrigerating appliance is divided by a plurality of compartment floors 7. Positioned in a recess of the rear lower region of the body 1 open to the exterior is a compressor 8 of a refrigerating machine of the refrigeration appliance. Other components of the refrigerating machine such as an evaporator and a liquefier are arranged in conventional fashion on the rear side of the inside wall 3 or respectively the outer wall 4 and are not illustrated in the figure.

An upper cover 9 of the body 1 is formed by a fixed work plate 10 and vertical flanks 11, which enclose the work plate on three of four sides and support it on the upper side of the outer wall 4. The cover 9 and the upper side of the outer wall 4 accordingly delimit a compartment 12, which is open to the front side of the appliance, to the right in the figure. This compartment 12 is provided to accommodate therein a carrier module 13 illustrated set back in the figure, which in the figure is illustrated in simplified fashion as a horizontal base plate 14 and an attached vertical screen 15. The screen 15 is such a size that, when the carrier module 13 is mounted in the compartment 12, it blanks off the open front side of the cover 9 fully and flush.

The leading edge of the work plate 10 projects a few centimetres over inside wall 3 and outer wall 4, so that when the door 2 is closed it is flush therewith. When the carrier module 13 of the compartment 12 is mounted, a rear region of the base plate 14 rests on the outer wall 4, while in a front region of the base plate 14 its underside forms a free outer face, lying opposite the closed door 2 over a narrow gap.

FIG. 2 shows a detailed view of the carrier module 13. The base plate 14 is an injection-moulded article made of plastic, which is provided with a plurality of transverse walls or legs 16 to reinforce and anchor diverse electrical or respectively electronic components. The screen 15 makes up a part separated from the base plate 14, which is mounted on the latter e.g. by snap-locking.

A printed circuit board 17 is mounted on the base plate 14 in vertical orientation, parallel to the screen 15 and at a short distance from the latter. This printed circuit board 17 bears, on its front side, in the figure covered by a wall 18 formed on the base plate 14, a plurality of switches, controllers or the like, which allow a user to switch the refrigeration appliance on and off, to set a nominal temperature of the inner area 6, etc., as well as a row of light-emitting diodes, connected via optical fibres to display elements 19 anchored in the wall 18. A control circuit 20 likewise attached to the printed circuit board 17, mainly on the rear side, is protected by a cover 21. The control circuit 20 is connected to a temperature sensor in the inner area 6 for receiving a temperature measuring signal, an den compressor 8 for switching on and off by way of the temperature measuring signal and connected to the switches, controllers and light-emitting diodes, and controls the latter according to a preset pattern, to display an operating status of the refrigerating appliance.

A second cover 22 covers a light bulb, arranged over a window formed in the base plate 14. The light bulb is switched on and off by a door-opening sensor 23 in the form of a simple on-and-off switch, which has a switch arm, not shown in the figure, reaching out over the underside of the base plate 14, which is in contact with the latter when the door 2 is closed and is switched on by it.

FIG. 2 also shows two pin-and-socket connectors 24, 25, which are attached to the rear side of the carrier module 13. The purpose of pin-and-socket connectors such as these is e.g. to guide a supply voltage for the control circuit 20, to send on and off signals to a switching relay of the compressor 8 or directly to the power supply of the compressor 8. In a refrigeration appliance with two temperature ranges a heating unit can be arranged on one of the two areas in a manner known per se; also, the latter can be switched or supplied via such a pin-and-socket connector 24,25.

FIG. 3 is a schematic horizontal section through the cover 9. The carrier module 13 and the pin-and-socket connector 24 are illustrated in outline only. The cover 9 is hollow inside as far as the carrier module 13. Coupled to the pin-and-socket connector 24 is a complementary pin-and-socket connector 26, forming the termination of a supply cable 27. The supply cable 27 runs freely through the interior of the cover 9 to a bevelled edge 28 on the rear side of the outer wall 4, and from there on the rear side downwards to the compressor 8. To prevent the latter from being pulled out of the pin-and-socket connector 26 by a pull on the part of the cable 27 running along the rear wall, the end section of the cable 27 connected to the pin-and-socket connector is held in a strain relief 29 of the carrier module 13.

As is evident from the comparison in FIGS. 2 and 4, the strain relief 29 is formed by a rectangular chamber formed on the base plate 14, which is divided by intersecting ribs 30 into four quarters and has inlet and outlet slots 31 in each case adjacent to one of the ribs 30. FIG. 3 shows the supply cable 27 pressed into the strain relief 29, whereby the cable is forced by the arrangement of the ribs 30 and the slots 31 to a meandering course with several opposite sharp bends. Because the upper edges of the outer walls of the chamber and of the ribs 30 make contact with the underside of the work plate 10 when in the mounted state, the cable 27 cannot escape from the strain relief 29.

FIG. 5 shows a section similar to that in FIG. 3 in a second embodiment of the inventive refrigerating appliance. In comparison to FIG. 3 a rear wall 32 extends here obliquely through the interior of the inventive cover 9, and a pin-and-socket connector 26 complementary to the pin-and-socket connector 24 of the carrier module 13 is set firmly in the rear wall 32 such that electrical contact between the pin-and-socket connectors 24, 26 is made automatically when the carrier module 13 is inserted into the compartment 12 limited by the rear wall 32. In this embodiment on the carrier module 13 there are no live parts, when the latter is withdrawn from the compartment 12, so that it can be worked on without any danger. This is particularly effective if a defective illuminating agent of the inner area illumination integrated in the carrier module 13 must be exchanged.

FIG. 6 shows a partial section through the carrier module 13 at the level of the cover 22. Set into a window 33 recessed in the base plate 14 is a glass pane 34 made of glass or a temperature-resistant plastic. The glass pane 34 is stuck or attached in some other way to the inside face of the base plate 14. On its lower edge the cover 22 has lateral projections 35, which engage in claws 36 formed behind on the base plate 14. Through gripping the cover 22 by hand and compression the projections 35 can be detached from the claws 36 and the cover can be raised along with a reflector 37 mounted in its interior, in order to expose the illuminating agent, here an incandescent lamp 38. The latter is now conveniently accessible and can be exchanged.

The glass pane 34 is provided on its upper side with a sawtooth profile so as to deflect the light radiated by the incandescent lamp 38 from the vertical to the side, that is, to the right in the figure, into the inner area 6 of the refrigerating appliance.

The construction of the inner area illumination shown in FIG. 6 requires that for exchanging the illuminating agent first the carrier module 13 is disassembled. Once this has happened the illuminating agent can be accessed very easily and conveniently.

It is understood that as an alternative a construction is also conceivable, in which the glass pane 34 is removed for exchanging of the illuminating agent and a user must reach through the then open window 33 to reach the illuminating agent.

1-13. (canceled)

14. A refrigeration appliance, comprising:
a housing;
said housing enclosing an inner area;
said inner area enclosed by a door;
a carrier module located in said housing; and
said carrier module including a control circuit for controlling the refrigerating capacity of the refrigeration appliance in said inner area depending on a temperature measuring signal related to the temperature in said inner area, at least one operating element for at least one of adjusting an operational parameter and a display element for displaying an operational parameter of said refrigeration appliance and at least one illuminating agent for illuminating at least some of said inner area.

15. The refrigeration appliance according to claim 14, including a compartment for said carrier module formed in an upper cover of said housing.

16. The refrigeration appliance according to claim 15, including said cover designed as a side or table plate fixed to the housing exterior.

17. The refrigeration appliance according to claim 15, including said carrier module and said compartment have at least a pair of electrical pin-and-socket connectors complementary to one another.

18. The refrigeration appliance according to claim 17, including said carrier module can be inserted into said compartment and said pin-and-socket connectors are arranged in a self-contacting manner when said carrier module is inserted into said compartment.

19. The refrigeration appliance according to claim 17, including said pin-and-socket connectors of said compartment each are arranged on a mobile cable and said carrier module includes a strain relief on which said cable can be fastened.

20. The refrigeration appliance according to claim 19, including said strain relief is formed as a meandering channel in which said cable can be placed.

21. The refrigeration appliance according to claim 15, including said carrier module has a free outer face facing an upper edge of said door and including at least one window formed in said free outer face through which said inner area can be lit up by said illuminating agent located in said carrier module.

22. The refrigeration appliance according to claim 21, including said window has a glass pane.

23. The refrigeration according to claim 22, including said glass pane is fixed to said carrier module.

24. The refrigeration appliance according to claim 21, including said carrier module bears a removable housing, which covers said illuminating agent.

25. The refrigeration appliance as claimed according to claim 15, including a door-opening sensor arranged on said carrier module.

26. The refrigeration appliance according to claim 15, including said inner area fitted with tray-shaped cool goods compartments, which can be withdrawn like a drawer.

27. A refrigeration appliance, comprising:
a housing;
said housing enclosing an inner area;
said inner area enclosed by a door;
a compartment formed in an upper cover of said housing
a carrier module located in said housing compartment;
said carrier module including a control circuit for controlling the refrigerating capacity of the refrigeration appliance in said inner area depending on a temperature measuring signal related to the temperature in said inner area, at least one operating element for at least one of adjusting an operational parameter and a display element for displaying an operational parameter of said refrigeration appliance and at least one illuminating agent for illuminating at least some of said inner area; and
said carrier module including at least one window formed therein through which said inner area can be lit up by said illuminating agent.
